(19) United States
(12) Patent Application Publication
(10) Pub. No.: US 2026/0016599 A1
(43) Pub. Date: Jan. 15, 2026

(54) SYSTEM FOR MEASURING THREE-DIMENSIONAL COORDINATES

(71) Applicant: FARO Technologies, Inc., Lake Mary, FL (US)

(72) Inventors: Rolf Heidermann, Stuttgart (DE); Ariane Stiebeiner, Stuttgart (DE)

(21) Appl. No.: 19/327,338

(22) Filed: Sep. 12, 2025

Related U.S. Application Data
(63) Continuation of application No. PCT/US24/18597, filed on Mar. 6, 2024.
(60) Provisional application No. 63/451,806, filed on Mar. 13, 2023.

(51) Int. Cl. G01S 17/42; G01S 7/481; G01S 7/484; G01S 7/4863; G01S 7/4865; G01S 7/4911; G01S 7/4914; G01S 7/4915; G01S 17/89

(52) U.S. Cl. CPC G01S 17/42; G01S 7/4814; G01S 7/4817; G01S 7/484; G01S 7/4863; G01S 7/4865; G01S 7/4911; G01S 7/4914; G01S 7/4915; G01S 17/89

(57) ABSTRACT

A system for measuring 3D coordinates of surfaces in the environment is provided. The system includes a body configured to rotate about an axis. A light source is configured to emit a pattern of light, the pattern of light. A two-dimensional array of pixels is coupled to the body and configured to receive a reflection of the pattern of light. A controller is electrically coupled to the light source and the two dimensional array of pixels, the controller configured to a determine a distance to at least one surface in the environment based at least in part on a reflection of the pattern of light from a surface in the environment and a speed of light in air.

### CROSS-REFERENCE TO RELATED APPLICATIONS

This application is a continuation of PCT Application Serial No. PCT/US24/18597 entitled System For Measuring Three-Dimensional Coordinates, filed Mar. 6, 2024, the contents of which are incorporated by reference herein, and this application claims priority to U.S. Provisional Application Ser. No. 63/451,806 entitled System For Measuring Three-Dimensional Coordinates, filed Mar. 13, 2023, the contents of which are incorporated by reference herein.

### BACKGROUND OF THE DISCLOSURE

The subject matter disclosed herein relates to system for measuring three-dimensional (3D) coordinates in an environment, and in particular to a system and method for measuring a pattern of light using a time of flight sensor.

A traditional time-of-flight (ToF) scanner is a scanner in which the distance to a target point is determined based on the speed of light in air of a beam of light traveling between the scanner and a target point. Traditional ToF scanners are typically used for scanning closed or open spaces such as interior areas of buildings, industrial installations and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object. For the case in which the light source within a scanner is a laser, such a scanner is often referred to as a laser scanner. The term laser scanner is often also used for scanners that use light sources that are not lasers, such as light sources using superluminescent diodes for example.

While existing systems for measuring a distance to an object are suitable for their intended purposes the need for improvement remains, particularly in providing 3D measurement system having the features described herein.

### BRIEF DESCRIPTION OF THE DISCLOSURE

According to one aspect of the disclosure a system for measuring 3D coordinates of surfaces in the environment is provided. The system includes a body configured to rotate about an axis. A light source is configured to emit a pattern of light, the pattern of light. A two-dimensional array of pixels is coupled to the body and configured to receive a reflection of the pattern of light. A controller is electrically coupled to the light source and the two dimensional array of pixels, the controller configured to a determine a distance to at least one surface in the environment based at least in part on a reflection of the pattern of light from a surface in the environment and a speed of light in air.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a system for measuring three-dimensional coordinates in accordance with an embodiment;

FIG. 2A is a schematic illustration of a direct time of flight (dToF) device for use with the system of FIG. 1;

FIG. 2B is a schematic illustration of an indirect time of flight (iToF) device for use with the system of FIG. 1;

FIG. 3A is a schematic illustration a first pattern used in measuring coordinates with the system of FIG. 1 accordance with an embodiment;

FIG. 3B is a schematic illustration a second pattern used in measuring coordinates with the system of FIG. 1 accordance with an embodiment;

FIG. 3C is a schematic illustration a third pattern used in measuring coordinates with the system of FIG. 1 accordance with an embodiment;

FIG. 3D is a schematic illustration a fourth pattern used in measuring coordinates with the system of FIG. 1 accordance with an embodiment;

FIG. 3E is a schematic illustration a fifth pattern that combines the third pattern and fourth pattern and is used in measuring coordinates with the system of FIG. 1 accordance with an embodiment;

FIG. 4 is a schematic illustration of a system for measuring three-dimensional coordinates in accordance with another embodiment; and

FIG. 5 is a schematic illustration of a system for measuring three dimensional coordinates in accordance with yet another embodiment.

The detailed description explains embodiments of the disclosure, together with advantages and features, by way of example with reference to the drawings.

### DETAILED DESCRIPTION OF THE DISCLOSURE

Time-of-Flight (ToF) measuring systems such as those used in laser scanners are typically one of two types: a phased-based ToF scanner or a pulsed ToF scanner. In a typical phase based ToF scanner, a beam of light is modulated at a plurality of frequencies before being launched to a target. After the modulated beam of light has completed a round trip to and from the target, it is demodulated to determine the returning phase of the each of the plurality of frequencies. A processor within the ToF scanner uses the demodulated frequencies and the speed of light in air to determine a distance from the scanner to the target. In contrast, a pulsed ToF scanner typically emits a short pulse of light and measures the elapsed time between launch of the pulse and return of the pulse after having completed a round trip to the target. A processor within the pulsed ToF scanner determines the distance from the scanner to the target based at based at least in part on the measured elapsed time and the speed of light in air. The ToF scanners used in laser scanners today typically include a single optical detector that measures the signal returned from the target. Such optical detectors typically measure to frequencies of several hundred MHz or to pulse widths of a few picoseconds to nanoseconds.

More recently, ToF methods are being employed in camera sensors having a collection or array of photosensitive elements. Each of the photosensors in the array serves the same function as the single optical detector in a traditional ToF laser scanner, but the photosensors typically are more limited in the speed of their response and their optical bandwidths. On the other hand, arrays of photosensors are relatively inexpensive, thereby offering advantages where the range and accuracy requirements are not as stringent as for traditional laser scanners.

A device that uses an array of sensors to measure pulsed light may be referred to as a direct ToF (or dToF) device. A device that uses an array of sensors to measure light modulated at multiple frequencies may be referred to as an indirect ToF (or iToF) device. If an array of pixels using dToF or iToF is included within a camera having a camera lens, then both distances and angles to the target points are determined based on the signals received by the array of pixels.

Embodiments of the present disclosure provide for a low cost system for measuring three-dimensional (3D) coordinates and generating a dense 3D point cloud. Embodiments of the present disclosure provide for a sensor array that allows for measurement of three-dimensional coordinates over an area based at least in part on the speed of light as the sensor array is rotated about an axis. Still further embodiments of the present disclosure provide for emitting a pattern of light onto one or more surfaces in the environment and measuring 3D coordinates of elements of the pattern using a dToF or iToF sensor.

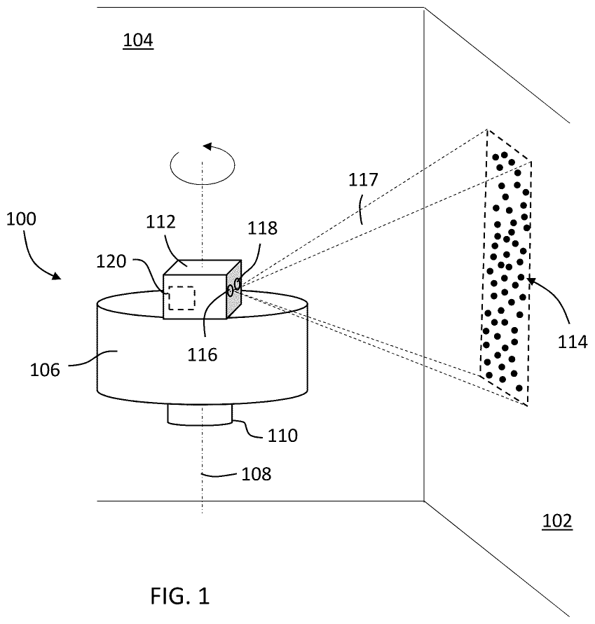

Referring now to FIG. 1, an embodiment of a system 100 is shown for measuring 3D coordinates on surfaces 102, 104 in an environment. The system 100 includes a body 106 that is configured to rotate about an axis 108. The body 106 is coupled to a suitable structure, such as a tripod for example. In an embodiment, the rotation or angular position of the body 106 is measured by a sensor 110, such as an angular encoder for example. The body 106 includes, or be coupled to, a suitable mechanism, such as a motor (not shown) that allows for the selective rotation of the body 106. In an embodiment, the body 106 is selectively rotated in incremental steps (e.g. a predetermined angular rotation) and paused for a predetermined amount of time. In still another embodiment, the body 106 is continuously rotated at a predetermined speed.

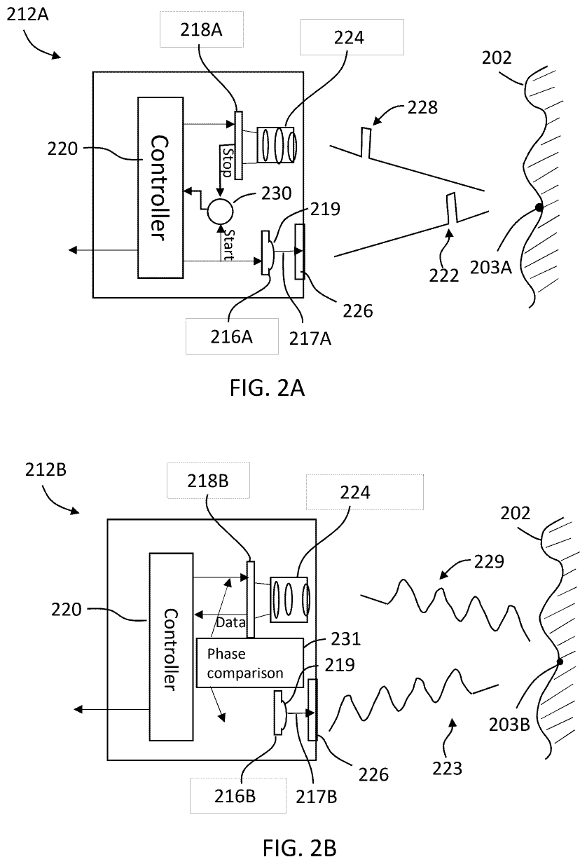

Coupled to the body 106 is a measurement device 112. In an embodiment, the measurement device includes a light source 116 that emits a light beam 117 that includes a pattern of light 114 projected on the surfaces 102, 104 as the body is rotated about the axis 108. The pattern of light 114 reflects off of the surfaces 102, 104 and passes through a camera lens 118 before being received by a two-dimensional (2D) photosensitive array, as described in FIG. 2A and FIG. 2B. As discussed in more detail below, the measurement device 112 includes a controller 120 that is configured to determine the 3D coordinates of elements of the pattern 114 where the distance or depth is determined based at least in part on the speed of light in air using either time-based or phase-based time-of-flight methods.

Referring now to FIG. 2A, an embodiment is shown of dToF device 212A. A dToF device is a device that measures distances to points on a surface 202 by emitting a pulsed beam of light 222 that intersects the surface 202 at one or more points. At least a portion of the light intersecting the surface 202 reflects back to the dToF device. In an embodiment, the device 212A includes a light source 216A, such as a laser light source that emits a beam of light 217A at a predetermined wavelength for example. In an embodiment, the beam of light 217A from light source 216A passes through one or more optical elements 226, such as a diffractive optical element, a Powell lens, or a combination of the foregoing for example. One or more additional lens elements 219 are included in the optical path prior to launching of the beam of light 222. The optical elements 226 receive the beam of light 217A from light source 216A and generate one or more structured beams of light that form the pattern of light on the surface 202. The pattern of light is comprised of elements that include dots, circles, ellipses, squares, polygons, and lines for example.

The light source 216A emits pulses of light 222 in response to signals from controller 220. The pulses of light 222 strikes the optical elements 226 to form a pulsed structured beam of light 222, which in turn leads to formation of a pattern of pulsed light on the surface 202. At least a portion of the light pulse 228 is reflected back towards the device 212A. In an embodiment, the reflected light pulse 228 passes through an imaging lens 224 before passing to a 2D photosensitive array 218A. By knowing the location of a particular spot on the photosensitive array 218A, an angular direction to a corresponding spot on the surface 202 can then be determined based on general properties of imaging lenses. In an embodiment, the 2D array 218A includes more than 1000 pixels/channels. In other embodiments, the 2D array has about 100,000 pixels/channels. The elapsed time for the light pulses 222 and 228 to complete a round trip from the one or more optical elements 226 to the imaging lens 224 is determined by a timer module 230 based at least in part on the elapsed time and the speed of light in air. It should be appreciated that in different embodiments, the timer module is integral with the controller 220 or is included in separate circuitry that transmits a signal to the controller 220. The 3D coordinates of the point 203A is determined based on the determined distance from the device 212A to a point on the surface 202 and on the angle from that point on the surface to the imaging lens 224.

It should be appreciated that while the example of FIG. 2A illustrates a single light pulse 222, the light pattern emitted by the light source 216A and/or optical elements 226 are represent a plurality of light pulses 222 that strike the surface 202 at different locations that each reflect back to the 2D array 218A to generate the pattern of light on the surface 202. As such, each of these plurality of light pulses 222 forms an element of the pattern for which a 3D coordinate is determined.

Referring now to FIG. 2B an embodiment is shown of an iToF device 212B. The iToF device 212B measures distances to points on the surface 202. A portion of an emitted beam of light 223 intersects the surface 202 in one or more points that include the point 203B. The beam of light 223 is modulated at a plurality of frequencies before being launched to a target. After the modulated beam of light has completed a round trip to and from the target, it is demodulated to determine the returning phase of the each of the plurality of frequencies. A processor within the iToF scanner uses the demodulated frequencies and the speed of light in air to determine a distance from the scanner to the target. In FIG. 2B, the iToF device measures distances to the surface 202 by emitting a pulsed beam of light 223 that intersects the surface 202, at least a portion of which reflects back to the iToF device. In an embodiment, the device 212B includes a light source 216B, such as a laser light source that emits light at a predetermined wavelength and a predetermined phase for example. In an embodiment, the light source 216B emits two beams of light with different phases, such as 0 and 180 degrees or 90 and 270 degrees for example. In other embodiments, the light source 216B emits four beams of light, each with a different phase, such as 0, 90, 180 and 270 for example. In still other embodiments, the light source 216B sequentially emits beams of light with each of the sequential beams of light having a different phase.

In an embodiment, the light source 216B, emits a beam of light 217B at a predetermined wavelength for example. In an embodiment, the beam of light 217B passes through one or more optical elements 226, such as a diffractive optical element, a Powell lens, or a combination of the foregoing for example. One or more additional lens elements 219 are included in the optical path prior to launching of the beam of light 223. The optical elements 226 receive the beam of light 217B from light source 216B and generate one or more structured beams of light that form the pattern of light on the surface 202. The pattern of light is comprised of elements that include dots, circles, ellipses, squares, polygons, and lines for example.

The light source 216B emits modulated light 223 in response to a signal from controller 220. The modulated light 223 strikes the optical elements 226 to form a modulated structured beam of light 223, which in turn leads to formation of a pattern of modulated light on the surface 202. At least a portion of the modulated light on the surface 202 is reflected back towards the device 212B. In an embodiment, the reflected modulated light passes through an imaging lens 224 before passing to a 2D photosensitive array 218B. The imaging lens 224 causes rays of light emerging from a particular point on the surface 202 to be focused onto a particular spot on the photosensitive array 218B. Hence, by knowing the location of the particular spot on the photosensitive array 218B, an angular direction to a corresponding spot on the surface 202 can be determined. In an embodiment, the 2D array 218A includes more than 1000 pixels/channels. In other embodiments, the 2D array is about 100,000 pixels/channels.

The reflected light 229 is received by pixels/channels on a 2D photosensitive array 218B. In an embodiment, the 2D array 218B includes more than 1000 pixels/channels. In other embodiments, the 2D array is about 100,000 pixels/channels. In an embodiment, the light pulse 229 passes through an imaging lens 224 before being received by the 2D photosensitive array 218B.

In the embodiment using the iToF device 212B, the distance is determined by a comparison module 231, which compares the phases of one or more modulated frequencies of the received beam to the phases of the one or more modulated frequencies of the emitted light beam. In an embodiment, phases of two light beams are compared (e.g. having phases 0 and 180 degrees). In another embodiment, phases of at least four light beams are compared (e.g. having phases of 0, 90, 180 and 270 degrees). In an embodiment, the 2D array acquires two images per frame, with each image being based on reflected light 229 having a different phase. In an embodiment, the 2D array is found on a Model IMX 556 or Model IMX 570 manufactured by Sony Corporation.

Once the distance and the position of the device 212B (e.g. the rotational angle about the axis 108) are determined, the three-dimensional coordinates of the point where the light pulse 223 intersects the surface 202 are determined.

In other embodiments, the device 212A, 212B is a frequency modulated continuous-wave (FMCW) lidar array. In this embodiment, the light source and photosensitive array are combined into a single device where each pixel/channel acts as a light source. As such, as used herein, the term light source includes a light source integrated into the photosensitive array.

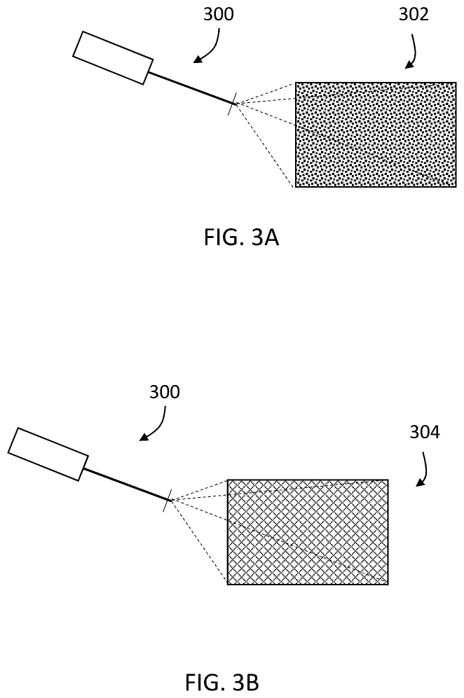

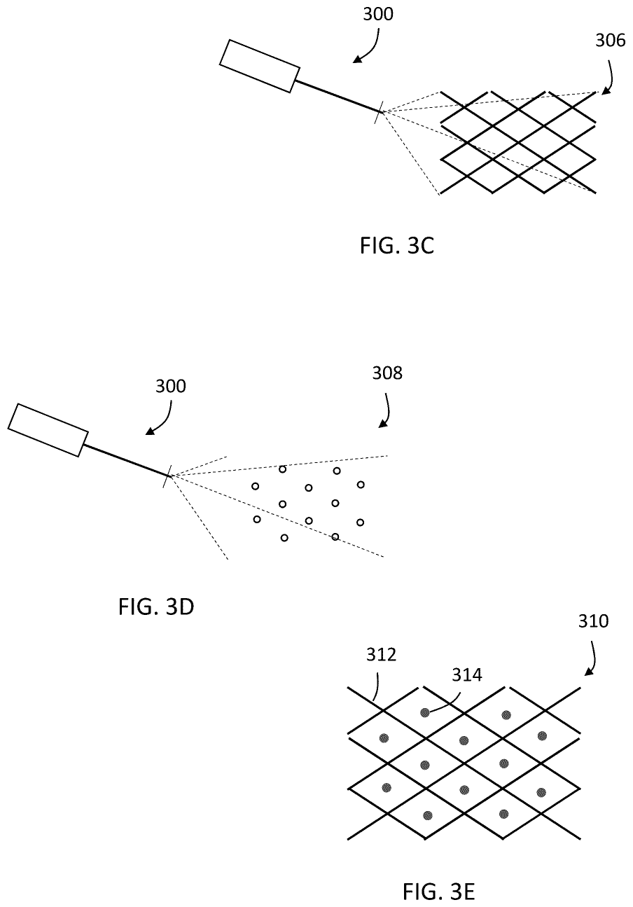

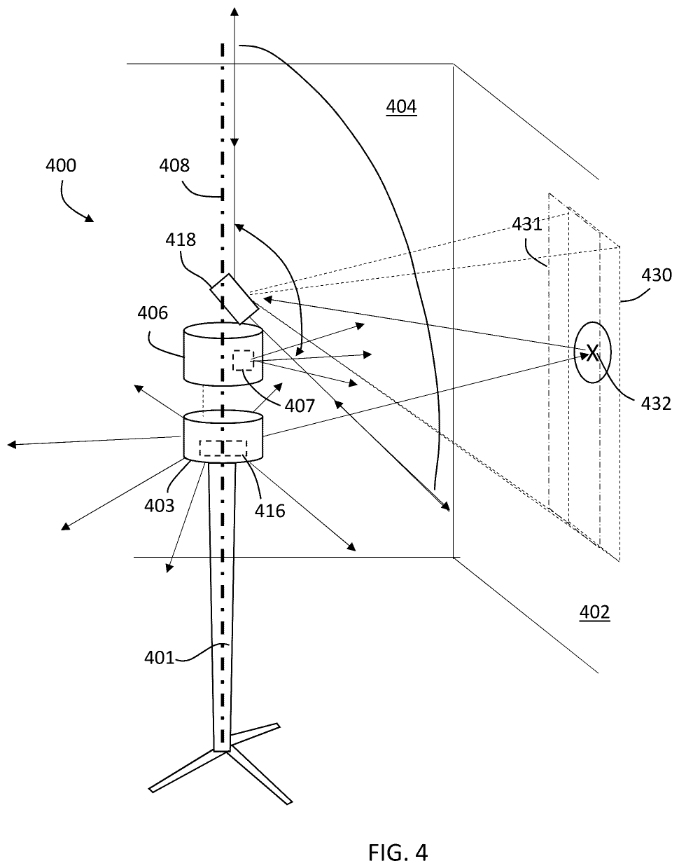

It should be appreciated that different types of patterns are used to generate a dense point cloud. Referring to FIGS. 3A-FIG. 3E, examples are shown of different patterns 302, 304, 306, 308, 310. These patterns, 302, 304, 306, 308, 310 are generated by optical elements such as a diffractive optical element or Powell lens 300 for example. In the embodiment of FIG. 3A, a pattern such as a dense random dot pattern 302 is projected by the light source. In the embodiment of FIG. 3B, a pattern such as a dense plurality of crossed lines are projected by the light source. In the embodiment of FIG. 3C, a pattern such a broadly spaced crossing line pattern 306. In the embodiment of FIG. 3D, a pattern such as a dot pattern 308 is projected by the light source. Finally, in the embodiment of FIG. 3E illustrates a pattern that combines and superimposes pattern 306 and pattern 308 to generate a pattern 310 that includes both dots and crossed lines.

In some embodiments, the elements of the pattern of light have different optical brightness levels. For example, the optical power emitted to generate the lines 312 is higher than the optical power emitted to generate the dots 314. In an embodiment, the pattern of light is comprised of a first plurality of elements and a second plurality of elements, where the first optical power of the light used to generate the first plurality of elements is larger than the second optical power of the light used to generate the second plurality of elements. In an embodiment, the first optical power is 1.5 times the second optical power.

It is known in the art to emit a pulse of light 222 that continuously covers a portion of a surface 202 before capturing the reflected light with a photosensitive array 218A of a dToF device or a photosensitive array 218B of an iToF device. A disadvantage of such an approach is that the power available to illuminate the area captured by each pixel of the photosensitive array 218A or 218B is limited, which reduces performance of such a dToF or iToF system. Reduced performance comes in the form of reduced accuracy, slower measurements, reduced maximum distances, or reduced ability to measure dark objects. By concentrating the emitted light into a reduced number of elements of a structured light pattern, each of the elements has a greater optical power, thereby improving performance. In particular, in many cases, it is preferable to obtain a relatively sparse collection of points at higher accuracy, longer distances, and higher data capture rates.

Referring now to FIG. 4, an embodiment is shown of a system 400 for measuring 3D coordinates of surfaces in the environment. The system 400 includes a stand or tripod 401 with a housing 403. The tripod 401 spaces the housing 403 a distance from of the floor of the environment where the scan is being performed. The housing 403 includes a second light source 416 that remains stationary during operation and emits a pattern of light in a 360 degree field about the housing 403.

Mounted to the housing 403 is a body 406 that is configured to rotate about an axis 408. The body 406 is rotated by a suitable device, such as a motor mounted within the body 406 or the housing 403. Coupled to the body 406 is a 2D photosensitive array 418 having a field of view that includes an area on surfaces in the environment, such as the area 430 on surface 402 for example. In an embodiment the field of view results in an area 430 is longer in a first direction parallel with the axis 408 than in a second direction perpendicular to the axis 408. In an embodiment, the body further includes a first light source 407 that emits a pattern of light that forms a pattern on surfaces in the environment. It should be appreciated that as the body 406 rotates during operation, the field of view 430 and the pattern of light from light source 407 each rotate about the axis 408 as well. Since the pattern of light is stationary the angle of rotation of the body 406 is determined based on sequential images acquired by the photosensitive array 418. In other words, a first element of the pattern of light that is acquired in a first image at a first pixel (or a first plurality of pixels) will also be acquired in a second sequential image (acquired temporally after the first image) at a second pixel (or second plurality of pixels). Based on the relative position of the first pixel and second pixel and the distance to the first element, the angle of rotation of the body 406 is determined. In an embodiment, the camera is positioned close to the rotation axis, which allows the rotation angle to be determined from the pixel position in the camera image.

In an embodiment, the 2D photosensitive array 418 is an iToF device that measures distance based on multiple images generated by light with different phases. It should be appreciated that are the body 406 rotates, the field of view of array 418 and hence the area 430 is also moving. As a result the 2D photosensitive array 418 is not able to acquire multiple images of the same location in a single frame. In an embodiment, the additional images of a point are acquired in one or more subsequent frames. It should be appreciated that a stationary light pattern being transmitted by light source 416, the pattern would be stationary on the same surface element and an illuminated image of that surface element can be acquired several times as long as that surface element is within field of view. In some embodiments, the light source 416 is phase modulated to allow a distance to be determined. For example, when the area 430 rotates to a second position represented by the area 431 on surface 402, the point 432 will be located in an image (e.g. having a 0 degree phase) acquired in area 430 and is also acquired in an image (e.g. having a 180 degree phase) acquired in area 431. With two (or more) images acquired with different phases of light, the distance to the point 432 is determined. It should be appreciated that since the pattern of light is stationary, the frames acquiring the point 432 are not sequential but rather are acquired after the housing 403 has rotated 360 degrees or more during operation. In other words, the area 431 and the point 432 are captured after the housing 403 has rotated more than 360, 720, 1080 or more degrees for example.

In an embodiment, by rotating the body 406 at least 360 degrees, 3D coordinates of points on surfaces, such as surfaces 402, 404 are determined and a relatively sparse point cloud generated from the second light pattern generated by light source 416.

It should be appreciated that the first light source 407 also emits a pattern of light (that rotates with the body 406) illuminates the surfaces of the environment. It should further be appreciated that the photosensitive array 418 acquires images of the same part of the pattern of light from light source 407 that is always visible in the field of view, however the elements of the rotating pattern are on different surface points/elements between sequential images (due to rotation of the body 406). In this embodiment, several illuminated images of the same surface element can be acquired when either the single light pattern element is wide enough such that the very next frame(s) are illuminated as well or there are several light pattern elements illuminating the same surface point/element several times with some rotation in between. In this case, the distribution of different phase delays over these different points in time can be random or systematic.

It should be appreciated that the use of the rotating light pattern in combination with the stationary light pattern provides a technical effect of increasing the density of the point cloud.

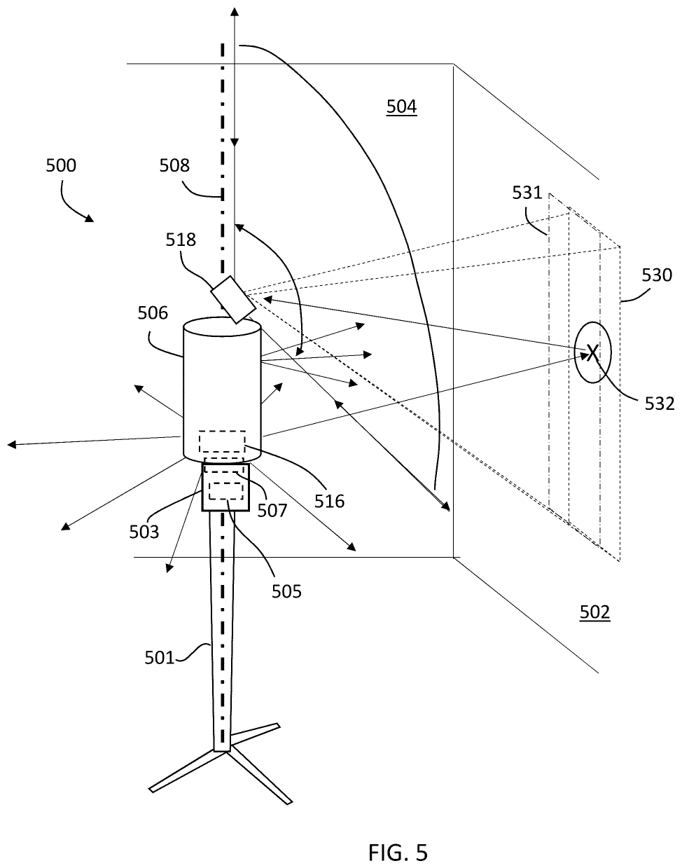

Referring now to FIG. 5, an embodiment is shown of a system 500 for measuring 3D coordinates of surfaces in the environment. The system 500 includes a stand or tripod 501 with a housing 503. In an embodiment, the tripod 501 positions the housing 503 a distance from the floor of the environment where the scan is being performed. Disposed within the housing 503 is a device, such as a motor 505. The motor 505 is coupled to a body 506. In an embodiment, rotary sensor, such as an encoder 507 for example, is operably coupled between the housing 503 and the body 506 to measure the rotation of the body 506 relative to the housing 503. The body 506 that is configured to rotate about an axis 408

In an embodiment, the body 506 further includes a light source 516 that rotates with the body 506 during operation and emits a pattern of light in a 360 degree field about the housing 503.

Further coupled to the body 506 is a 2D photosensitive array 518 having a field of view that includes an area on surfaces in the environment, such as the area 530 on surface 502 for example. In an embodiment the field of view results in an area 530 is longer in a first direction parallel with the axis 508 than in a second direction perpendicular to the axis 508. It should be appreciated that as the body 506 rotates during operation, the field of view defined by area 530 rotates about the axis 508 as well. As discussed above with respect to FIG. 4, the light pattern generated by the light source 516 is acquired in sequential images within the field of view of the photosensitive array 518. In an embodiment, the light source 516 emits light with a field of view that is slightly larger (e.g. <10%) than the field of view of the a 2D photosensitive array 518. In an embodiment, the field of view of the light source 518 is larger than the 2D photosensitive array in the direction of parallax movement.

In an embodiment, the 2D photosensitive array 518 is an iToF device that measures distance based on multiple images generated by light with different phases. It should be appreciated that are the body 506 rotates, the field of view of array 518 and hence the area 530 is also moving. As a result the 2D photosensitive array 518 is not able to acquire multiple images of the same location (e.g. the first point 532) in a single frame. In an embodiment, the additional images of each point on the surface are acquired in one or more subsequent frames. For example, the pattern element at point 532 is large enough such that when the area 530 rotates to a second position represented by the area 531 on surface 502, the point 532 will be located at a first pixel in a first image (e.g. having a 0 degree phase) acquired in area 530 and is also acquired at a second pixel in a second image (e.g. having a 180 degree phase) acquired in area 531. In other embodiments, several pattern elements are illuminate the same surface point/element (e.g. point 532) several times with some rotation in between. With two (or more) images acquired with different phases of light, the distance to the point 532 is determined. It should be appreciated that since the pattern of light is rotates with the body 506, the frames acquiring the point 532 are not sequential but rather are acquired after the body 506 has rotated 360 degrees or more during operation. In other words, the area 530 and the point 532 are captured after the body 506 has rotated 360, 720, 1080 or more degrees for example.

In another embodiment several pattern elements are used in the field of view with one pattern element being emitted at a first phase on one surface element and a second pattern element with a second phase being emitted on the same surface element. In an embodiment, this is performed using pattern elements that are wide enough (at least perpendicular to the rotation axis) such that after rotation during the time between two phase-frames, there is still a portion of the pattern element on the same surface element. Then two or more consecutive frames can be used and then alternating the phase, there is deterministically is at least two phase images of the same surface element.

In another embodiment, only the 2 phases acquired during a first phase frame are used. As a result only a single image is used to determine a distance. However, it be desirable also in this configuration to combine two images (e.g. to reduce noise or susceptibilities to speckle, inhomogeneous illumination, etc.).

By rotating the body 506 at least 360 degrees, 3D coordinates of points on surfaces, such as surfaces 502, 504 are determined (based on the depth measurements to the elements in the light pattern and the encoder 507 measurements) and a point cloud generated.

According to one aspect of the disclosure a system for measuring 3D coordinates of surfaces in the environment is provided. The system includes a body configured to rotate about an axis. A light source is configured to emit a pattern of light, the pattern of light. A two-dimensional array of pixels is coupled to the body and configured to receive a reflection of the pattern of light. A controller is electrically coupled to the light source and the two dimensional array of pixels, the controller configured to a determine a distance to at least one surface in the environment based at least in part on a reflection of the pattern of light from a surface in the environment and a speed of light in air.

In addition to one or more of the features described herein, or as an alternative, further embodiments of the system may include the emitted pattern of light having at least one predetermined phase, and the distance is further based in part on a change in the at least one predetermined phase between the emitted pattern of light and the received reflection of the pattern of light.

In addition to one or more of the features described herein, or as an alternative, further embodiments of the system may include the emitted pattern of light being a light pulse, and the distance is further based in part on the amount of time between the emitting of the light pulse and the receiving of the light pulse by the two-dimensional array of pixels.

In addition to one or more of the features described herein, or as an alternative, further embodiments of the system may include the pattern of light being a combination of dots and lines.

In addition to one or more of the features described herein, or as an alternative, further embodiments of the system may include the light source being a vertical-cavity surface-emitting laser (VCSEL).

In addition to one or more of the features described herein, or as an alternative, further embodiments of the system may include the light source further including a microlens array arranged to receive laser light from the VCSEL and generate the pattern of light.

In addition to one or more of the features described herein, or as an alternative, further embodiments of the system may include the light source including a diffractive optical element configured to receive a beam of light and generate the pattern of light.

In addition to one or more of the features described herein, or as an alternative, further embodiments of the system may include the light source further including a diffractive optical element or a Powell lens configured to generate a line of light.

In addition to one or more of the features described herein, or as an alternative, further embodiments of the system may include the pattern of light including a plurality of elements, the plurality of elements includes a first plurality of elements having a first optical power and a second plurality of elements having a second optical power, the second optical power being larger than the first optical power.

In addition to one or more of the features described herein, or as an alternative, further embodiments of the system may include the second optical power being 1.5 times larger than the first optical power.

In addition to one or more of the features described herein, or as an alternative, further embodiments of the system may include the light source being in a fixed position relative to the body.

In addition to one or more of the features described herein, or as an alternative, further embodiments of the system may include the controller being further configured to determine an angle of rotation of the body based at least in part on the pattern of light.

In addition to one or more of the features described herein, or as an alternative, further embodiments of the system may include the pattern of light being emitted in a 360 degree field of view about the body.

In addition to one or more of the features described herein, or as an alternative, further embodiments of the system may include a measurement sensor operably coupled to measure a rotational position of the body, the measurement sensor being coupled for communication to the controller.

In addition to one or more of the features described herein, or as an alternative, further embodiments of the system may include the pattern of light including a plurality of elements, the plurality of elements includes a first element. The controller may further be configured to acquire a first image of the first element at a first rotational position of the body and a second image of the first element at a second rotational position of the body, and determine a three-dimensional coordinate of the first element based at least in part on the first image, the second image, the first rotational position and the second rotational position.

In addition to one or more of the features described herein, or as an alternative, further embodiments of the system may include the first image acquiring an image of the first element with a first pixel and the second image acquires an image of the first element with a second pixel, the first pixel being different than the second pixel.

In addition to one or more of the features described herein, or as an alternative, further embodiments of the system may include the two-dimensional array of pixels having a first field of view oriented parallel to the axis and a second field of view oriented perpendicular to the axis.

In addition to one or more of the features described herein, or as an alternative, further embodiments of the system may include the first field of view being larger than the second field of view.

In addition to one or more of the features described herein, or as an alternative, further embodiments of the system may include at least one reflective target disposed on the surface.

In addition to one or more of the features described herein, or as an alternative, further embodiments of the system may include the at least one reflective target is a retroreflective target.

The term “about” is intended to include the degree of error associated with measurement of the particular quantity based upon the equipment available at the time of filing the application. For example, “about” can include a range of +8% or 5%, or 2% of a given value.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.” It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A system for measuring 3D coordinates of surfaces in the environment, the system comprising:
a body configured to rotate about an axis;
a light source configured to emit a pattern of light;
a two-dimensional array of pixels coupled to the body and configured to receive a reflection of the pattern of light;
a controller electrically coupled to the light source and the two dimensional array of pixels, the controller configured to a determine a distance to at least one surface in the environment based at least in part on a reflection of the pattern of light from a surface in the environment and a speed of light in air; and
a measurement sensor operably coupled to measure a rotational position of the body, the measurement sensor being coupled for communication to the controller;
wherein the pattern of light includes a plurality of elements, the plurality of elements includes a first element, the controller is further configured to acquire a first image of the first element at a first rotational position of the body and a second image of the first element at a second rotational position of the body, and determine a three-dimensional coordinate of the first element based at least in part on the first image, the second image, the first rotational position and the second rotational position.

2. The system of claim 1, wherein the emitted pattern of light has at least one predetermined phase, and the distance is further based in part on a change in the at least one predetermined phase between the emitted pattern of light and the received reflection of the pattern of light.

3. The system of claim 1, wherein the emitted pattern of light is a light pulse, and the distance is further based in part on the amount of time between the emitting of the light pulse and the receiving of the light pulse by the two-dimensional array of pixels.

4. The system of claim 1, wherein the pattern of light is a combination of dots and lines.

5. The system of claim 1, wherein the light source is a vertical-cavity surface-emitting laser (VCSEL).

6. The system of claim 5, wherein the light source further includes a microlens array arranged to receive laser light from the VCSEL and generate the pattern of light.

7. The system of claim 1, wherein the light source includes a diffractive optical element configured to receive a beam of light and generate the pattern of light.

8. The system of claim 1, wherein the light source further includes a diffractive optical element or a Powell lens configured to generate a line of light.

9. The system of claim 1, wherein the plurality of elements of the pattern of light includes a first plurality of elements having a first optical power and a second plurality of elements having a second optical power, the second optical power being larger than the first optical power.

10. The system of claim 9, wherein the second optical power is 1.5 times larger than the first optical power.

11. The system of claim 1, wherein the light source is in a fixed position relative to the body.

12. The system of claim 11, wherein the controller is further configured to determine an angle of rotation of the body based at least in part on the pattern of light.

13. The system of claim 11, wherein the pattern of light is emitted in a 360 degree field of view about the body.

14. The system of claim 9, wherein elements of the first plurality of elements comprise a first type and elements of the second plurality of elements comprise a second type different from the first type, where the first optical power is emitted by the light source to generate the elements of the first plurality of elements comprising the first type, and the second optical power that is larger than the first optical power is emitted by the light source to generate the elements of the second plurality of elements comprising the second type.

15. The system of claim 1, further comprising an imaging lens that causes the reflection of the pattern of light reflected from the at least one surface in the environment to be focused on a location of the two-dimensional array, where the controller uses the location of the reflection of the pattern of light on the two-dimensional array to determine an angular direction from the location on the two-dimensional array to a corresponding location on the at least one surface in the environment, the angular direction being used to measure the 3D coordinates in the environment.

16. The system of claim 1, wherein the first image acquires an image of the first element with a first pixel and the second image acquires an image of the first element with a second pixel, the first pixel being different than the second pixel.

17. The system of claim 1, wherein the two-dimensional array of pixels has a first field of view oriented parallel to the axis and a second field of view oriented perpendicular to the axis.

18. The system of claim 17, wherein the first field of view is larger than the second field of view.

19. The system of claim 1, further comprising at least one reflective target disposed on the surface.

20. The system of claim 19, wherein the at least one reflective target is a retroreflective target.
